(19) United States
(12) Patent Application Publication
(10) Pub. No.: US 2014/0086533 A1
(43) Pub. Date: Mar. 27, 2014

(54) METHOD FOR ALIGNMENT BETWEEN TWO OPTICAL COMPONENTS

(71) Applicants: Ezra GOLD, Sunnyvale, CA (US); Benoit SEVIGNY, Lille (FR); Yannick LIZE, Sunnyvalr, CA (US)

(72) Inventors: Ezra GOLD, Sunnyvale, CA (US); Benoit SEVIGNY, Lille (FR); Yannick LIZE, Sunnyvalr, CA (US)

(21) Appl. No.: 13/657,249

(22) Filed: Oct. 22, 2012

Related U.S. Application Data
(60) Provisional application No. 61/706,674, filed on Sep. 27, 2012.

(51) Int. Cl. G02B 6/42

(52) U.S. Cl. CPC G02B 6/42
USPC 385/52; 29/428

(57) ABSTRACT

A method for aligning two optical assemblies comprises positioning a first optical assembly in relation to a second optical assembly and securing the first optical assembly to the second optical assembly. The positioning aligns a plurality of first alignment features of the first optical assembly to a plurality of second alignment features of the second optical assembly. Aligning the first alignment features to the second alignment features aligns the second optical assembly to a plurality of optical components on the first optical assembly.

### CROSS-REFERENCES TO RELATED APPLICATIONS

This application claims the benefit of Provisional Application No. 61/706,674, filed on Sep. 27, 2012, titled “METHOD FOR ALIGNMENT BETWEEN TWO OPTICAL COMPONENTS,” by Ezra Gold, which is herein incorporated by reference.

### TECHNICAL FIELD

The present disclosure relates generally to the field of optical components and more specifically to the field of optical component alignment and connection.

### BACKGROUND

Fiber-optic communications have revolutionized the telecommunications and data communications industries, providing many advantages over traditional electrical transmission via copper wires. At a basic level, fiber-optic transmission begins with the creation of a light signal (a series of light pulses that carry the information from an electrical signal). The light signal is created with an optic transmitter (e.g. a laser emitter). The light signal is then relayed through a fiber network to a destination point where it is received by an optic receiver (e.g. a photo-diode receiver) and converted back into the electrical signal.

For fiber-optics to work correctly, very precision alignment is necessary between optic components. For example, optic transmitters and optic receivers must be very precisely aligned to an optic component, such as an optical lens assembly for connection to a fiber-optic line. Furthermore, an optical connection that includes an alignment of an optical component to another optical component (the optical components may be optical lenses, optical fibers, lasers, detectors, or some other optical device) requires a precision alignment and connection between the two optical components. Ensuring the alignment of optical components is often a time consuming and tedious process.

One method for aligning two optical components makes use of a precision machined sleeve to control the alignment between the two optical components. However, mechanical tolerances for the sleeve and the component that fits into the sleeve (e.g. a bare optical fiber or a fiber mounted in a plug assembly) are very high and may be costly to produce.

Another method for aligning two optical components is to mount the optical components in groups to a rigid body. An exemplary rigid body may comprise two pins or sleeves, similar in design to the first method, mounted to the rigid body to facilitate alignment. In this case many components may be mounted with a pair of these high cost alignment features. However, since two features are used to control alignment, the alignment between the two features must be controlled at the same level as the feature itself. This further increases cost and the difficulties of manufacture.

In both of these methods the two mating components may be over constrained, where the parts when fit together will have interference if not manufactured to a high degree of perfection. Because of the usual tolerances found in most manufacturing processes, this overconstrained condition requires tighter manufacturing tolerances for both repeatability and accuracy. In other words, overconstrained conditions may lead to higher levels of stress in assembled components, such that manufacturing or assembly errors are more likely to result in a system failure.

### SUMMARY OF THE INVENTION

Embodiments of this present invention provide solutions to the challenges inherent in aligning optical assemblies. In a method according to one embodiment of the present invention, a method for aligning two optical assemblies is disclosed. The method comprises positioning a first optical assembly in relation to a second optical assembly and securing the first optical assembly to the second optical assembly. The positioning aligns a plurality of first alignment features of the first optical assembly to a plurality of second alignment features of the second optical assembly. Aligning the first alignment features to the second alignment features aligns the second optical assembly to a plurality of optical components on the first optical assembly.

In an apparatus according to one embodiment of the present invention, an alignment apparatus is disclosed. The alignment apparatus comprises a first optical assembly, a second optical assembly, and a retainer. The first optical assembly comprises a plurality of first alignment features. The second optical assembly comprises a plurality of second alignment features. The retainer is operable to hold the first optical assembly in physical contact with the second optical assembly. The first alignment features are aligned to the second alignment features. The second optical assembly is aligned to a plurality of optical components of the first optical assembly.

### BRIEF DESCRIPTION OF THE DRAWINGS

Embodiments of the present invention will be better understood from the following detailed description, taken in conjunction with the accompanying drawing figures in which like reference characters designate like elements and in which:

FIG. 1A illustrates an exemplary simplified overhead diagram of an optical assembly with a plurality of recessed alignment features, in accordance with an embodiment of the present invention;

FIG. 1B illustrates an exemplary simplified side-view diagram of the optical assembly of FIG. 1A, along line A, in accordance with an embodiment of the present invention;

FIG. 1C illustrates an exemplary simplified side-view diagram of the optical assembly of FIG. 1A, along line B, in accordance with an embodiment of the present invention;

FIG. 1D illustrates an exemplary simplified overhead diagram of an optical assembly with a plurality of protruding alignment features, in accordance with an embodiment of the present invention;

FIG. 1E illustrates an exemplary simplified side-view diagram of the optical assembly of FIG. 1D, along line C, in accordance with an embodiment of the present invention;

FIG. 1F illustrates an exemplary simplified side-view diagram of the optical assembly of FIG. 1D, along line D, in accordance with an embodiment of the present invention;

FIG. 1G illustrates an exemplary simplified side-view diagram of the optical assembly of FIG. 1B aligned and positioned on the optical assembly of FIG. 1E, in accordance with an embodiment of the present invention;

FIG. 1H illustrates an exemplary simplified side-view diagram of the optical assembly of FIG. 1C aligned and positioned on the optical assembly of FIG. 1F, in accordance with an embodiment of the present invention;

FIG. 2A illustrates an exemplary 3D view of an exemplary optical assembly with protruding alignment features, in accordance with an embodiment of the present invention;

FIGS. 2B and 2C illustrate exemplary 3D views of the optical assembly of FIG. 2A aligned with an optical assembly with recessed alignment features, in accordance with an embodiment of the present invention;

FIG. 3 illustrates a flow diagram, illustrating the steps to a method for assembling an optical connection in accordance with an embodiment of the present invention; and

FIGS. 4A and 4B illustrate exemplary simplified block diagrams of a pair of optical assemblies mated together and held in position in accordance with an embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

Embodiments of this present invention provide solutions to the increasing challenges inherent in aligning and connecting two molded optical components or assemblies. Various embodiments of the present disclosure provide fast and reliable coupling of two molded optical components for low cost manufacturing or for use as an optical connector. Further, the pair of optical components may be reliably and repeatedly aligned and connected together.

As discussed in detail herein, embodiments of the present invention provide a method and apparatus for aligning and connecting two optical components that replaces a conventional precision sleeve with a kinematic or quasi-kinematic mount comprising three curved surfaces and three matching grooves. Such a connection/mount (utilizing kinematic or quasi-kinematic connections) allows repeatable assembly of the two optical components in a minimum constraint condition. A minimum constraint may be achieved when any change in component geometry results in a mounting position change, but without inducing additional stress onto the optical components. With such a “minimum constraint” condition, a repeatability of the assembly is only reliant upon the repeatability of the optical components. While accuracy is desired, errors in accuracy may be compensated for in other areas of the system so long as there is repeatability between components.

The difference between accuracy and repeatability is important because standard plastic molding practice indicates that while accuracy for molding accurate components may be about +/−25 μm, the repeatability may be about +/−1 μm. In a case where there is a direct reliance on accuracy in the manufacturing process, significant additional cost and development time may be required because the manufacturing process may require several iterative steps to achieve the desired level of accuracy. For example, a plastic mold may be created, components molded, the molded components measured, adjustments made to the mold based upon the measurements, and then the previous steps repeated until a desired mold accuracy, sufficient for the design, is achieved. With the minimum constraint system as described herein, components may be successfully molded to within a desired degree of accuracy required on a first attempt, such that further mold adjustments are not required.

As described herein, an exemplary method may be modified to accommodate situations where more tolerance is allowed in some directions or axes of rotation than in others. In such a case, a kinematic or quasi-kinematic mount may be relied on to control only a subset of the available degrees of freedom between the optical components and to allow the remaining directions or degrees of freedom to move within limits. Such an arrangement may allow more tolerance in component accuracy and allow more robust component structures to be created.

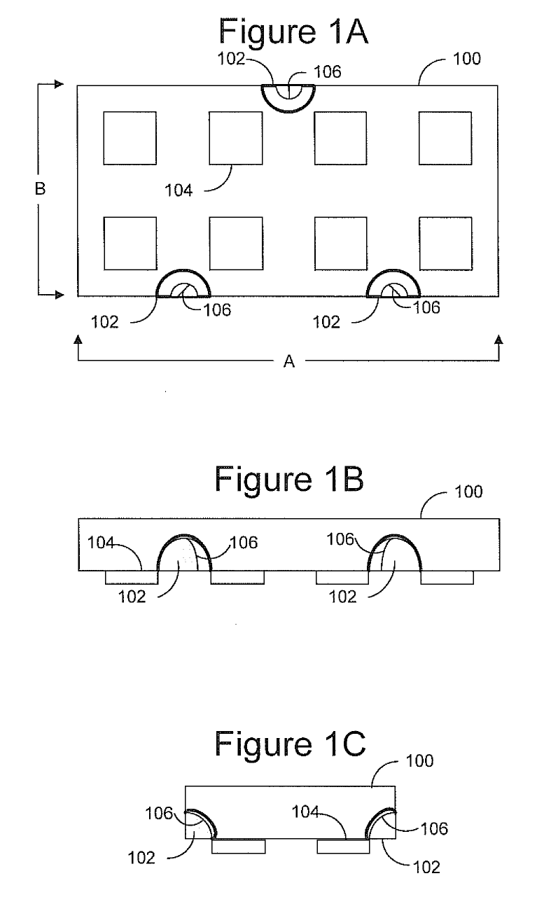

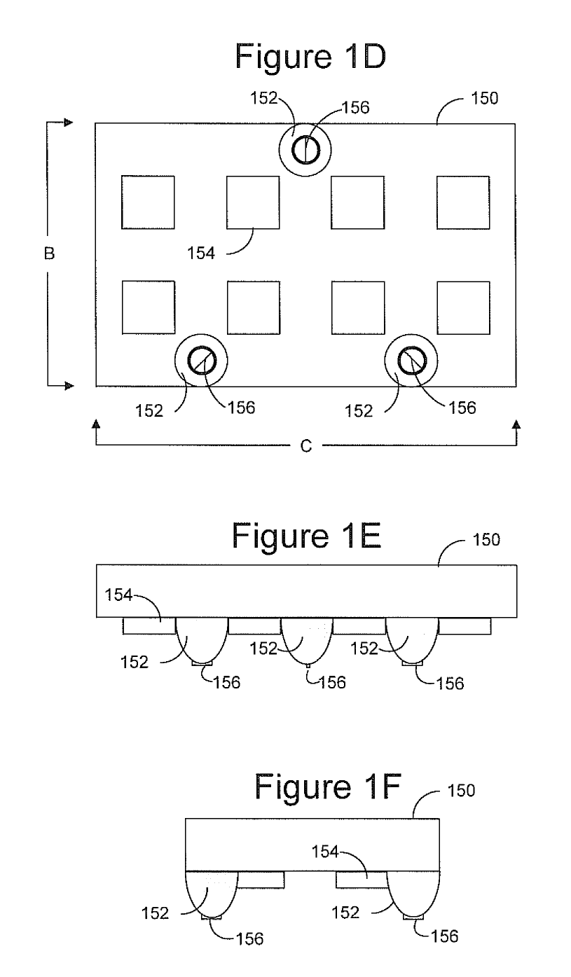

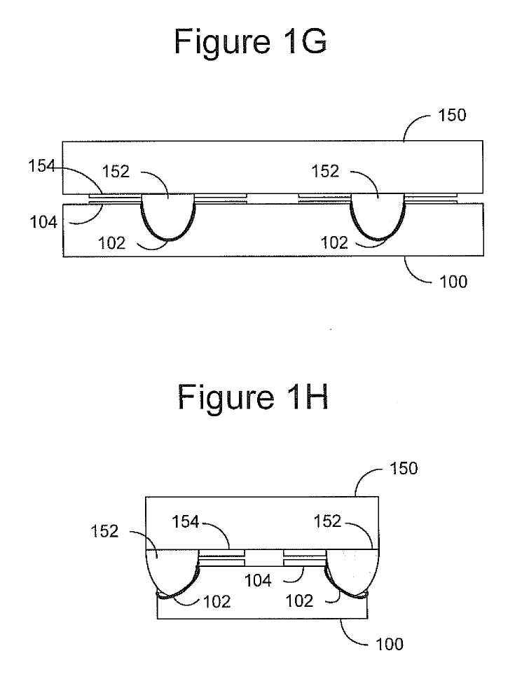

FIGS. 1A, 1B, and 1C illustrate a top view and two side views, respectively, of an exemplary molded optical assembly 100 with a plurality of recessed alignment features 102. The molded optical assembly 100 illustrated in FIGS. 1A-1C also comprises a plurality of optical assemblies 104. In one exemplary embodiment, the optical assemblies 104 are optical lenses. In one exemplary embodiment there are eight optical lenses 104 arranged on the optical assembly 100. As further illustrated in FIGS. 1B and 1C, the arranged optical assemblies 104 may protrude from the surface of the molded optical assembly 100. FIGS. 1B and 1C also further illustrate an exemplary shape of the recessed alignment features 102. The recessed alignment features 102 illustrated in FIGS. 1A-1C are exemplary in nature and are not intended to be limiting. It is understood that other exemplary alignment features 102 may be manufactured following other shapes or arrangements and are also considered to be within the scope of this disclosure.

In one exemplary embodiment, a recessed alignment feature 102 may further comprise kinematic or quasi-kinematic features 106. As described herein, an alignment feature utilizing kinematic features may comprise mechanical contacts on a pair of assemblies that are designed in such a way that the mechanical contacts may be used to locate the assemblies with respect to each other. Kinematic couplings allow a precise and repeatable orientation between assemblies. For example, as illustrated in FIGS. 1A-1C, each recessed alignment feature 102 may comprise an exemplary groove 106 fitted to receive a protruding alignment feature (e.g., a ridge fit to match a corresponding recess) of a corresponding align feature of another optical assembly. As discussed herein, when a recessed alignment feature of a first optical assembly is aligned and mated with a protruding alignment feature of a second optical assembly, the two optical assemblies may be accurately located with respect to each other. In other words, with such kinematic alignment features 102, 106, an optical assembly may only be mated with another optical assembly in a precise manner allowing an accurate, yet efficient method and apparatus for alignment of molded optical assemblies. The degree of accuracy required by a matching molded optical assembly to mate with a corresponding molded optical assembly utilizing kinematic or quasi-kinematic alignment features may be adjusted to reach a level of desired constraint in the six degrees of freedom of movement. For example, different shapes and feature orientations may be utilized to increase or decrease the level of constraint achieved from a kinematic alignment feature pairing.

As illustrated in FIG. 1A, in one embodiment, while a kinematic feature 106 of a lone recessed alignment feature 102 in the middle of a top edge of the molded optical assembly 100 is a recessed groove extending along the recessed alignment feature 102 in a line parallel to the sides of the molded optical assembly 100, the kinematic features 106 of the remaining two recessed alignment features 102 arranged on a bottom edge of the molded optical assembly 100 comprise recessed grooves that are arranged to extend along their respective recessed alignment features 102 to point inward towards a center of the molded optical assembly 100. Other exemplary embodiments may utilize other shapes and orientations or groove directions to form kinematic features 106.

FIGS. 1D, 1E, and 1F illustrate a top view and two side views, respectively, of an exemplary molded optical assembly 150 with a plurality of protruding alignment features 152. The molded optical assembly 150 illustrated in FIGS. 1D-1F also comprises a plurality of optical components 154. In one exemplary embodiment, the optical components 154 are optical lenses. In one exemplary embodiment there are eight optical lenses 154 arranged on the optical assembly 150. As illustrated in FIGS. 1E and 1F, the arranged optical components 154 may protrude from a top surface of the mold optical assembly 150. FIGS. 1E and 1F also further illustrate an exemplary shape of the protruding alignment features 152. The protruding alignment features 152 illustrated in FIGS. 1D-1F are exemplary in nature and are not intended to be limiting. It is understood that other exemplary alignment features 152 may be manufactured following other shapes or arrangements and are also considered to be within the scope of this disclosure.

In one exemplary embodiment, as illustrated in FIGS. 1D-1F, the protruding alignment features 152 may also comprise kinematic or quasi-kinematic features 156. In one exemplary embodiment, as illustrated in FIGS. 1D-1F, kinematic features 156 comprise protruding ridges on the ends of each protruding alignment feature 152. As illustrated in FIGS. 1D-1F, the kinematic features 156 may be orientated and formed to provide a desired level of constraint in the six degrees of freedom of movement between a pair of optical components joined by kinematic connections. As illustrated in FIG. 1D, while a kinematic feature 156 of a single protruding alignment feature 152 on a top edge of the molded optical assembly 150 is a protruding ridge extending across a top portion of the protruding alignment feature 152 parallel to the sides of the molded optical assembly 150, the kinematic features 156 of the remaining two protruding alignment features 152 arranged on a bottom edge of the molded optical assembly 150 comprise protruding ridges that are arranged to extend across the tops of their respective protruding alignment features 152 to point inward towards a center of the molded optical assembly 150. Other exemplary embodiments may utilize other shapes and orientations or groove directions to form kinematic features 156.

FIGS. 1G and 1H illustrate an exemplary mating of a molded optical assembly 100 with recessed alignment features 102 with a molded optical assembly 150 with protruding alignment features 152. As also illustrated in FIGS. 1G and 1H, the optical components 104 of the molded optical assembly 100 with recessed alignment features 152 are aligned with the optical components 154 of the molded optical assembly 150 with protruding alignment features 152. An exemplary side-view illustrated in FIG. 1G corresponds to the side-views of FIGS. 1B and 1E, while an exemplary side-view illustrated in FIG. 1H corresponds to the side-views of FIGS. 1C and 1F.

In one embodiment, the protruding alignment features 152 and recessed alignment features 102 may also comprise kinematic features 156, 106, respectively. As illustrated in FIGS. 1G and 1H, the kinematic features 106, 156 are not visible as they are mated together. While additional portions of the kinematic features 106, 156 may be visible when different orientations or formations are utilized, any portion of a kinematic feature 106, 156 that may be visible from the orientations and formations illustrated in FIGS. 1A-1F have been eliminated from FIGS. 1G and 1H for the sake of clarity.

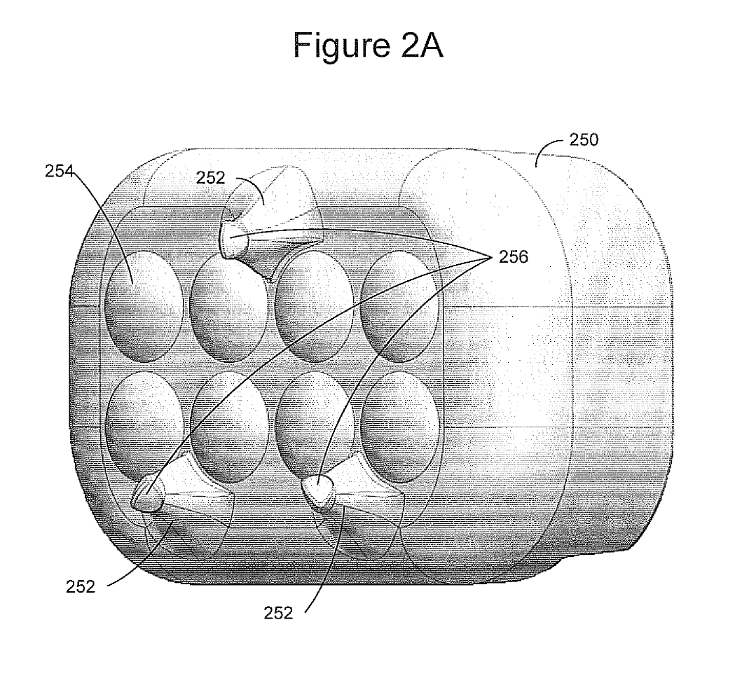

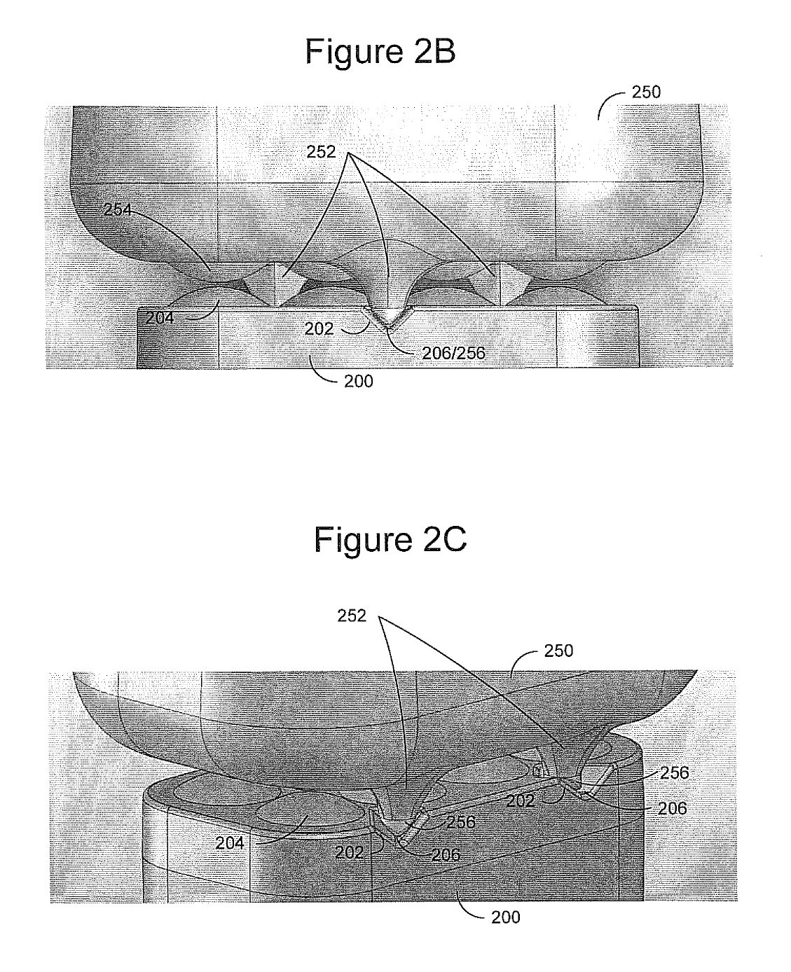

FIG. 2A illustrates an exemplary three-dimensional view of a molded optical assembly 250. The mold optical assembly 250 illustrated in FIG. 2A comprises a plurality of protruding alignment features 252 that are arranged around the circumference of a side of the molded optical assembly 250. The same side of the molded optical assembly 250 also comprises a plurality of optical components 254 arranged between the protruding alignment features 252. In one exemplary embodiment, the optical components 254 are optical lenses. In one exemplary embodiment, the molded optical assembly 250 is an optical lens assembly comprising a plurality of optical lenses. The molded optical assembly 250 illustrated in FIG. 2A comprises eight optical components 254. In other embodiments a variety of different quantities of optical components 254 may be arranged on the molded optical assembly 250. In one embodiment, 2-60 optical components 254 may be arranged on the molded optical assembly 250.

In one exemplary embodiment, as illustrated in FIG. 2A, each protruding alignment feature 252 may also comprise a kinematic or quasi-kinematic feature 256. In one embodiment, as illustrated in FIG. 2A, the kinematic features 256 are protruding ridges on the ends of each protruding alignment feature 252. As illustrated in FIG. 2A, the kinematic features 256 may be orientated and formed to provide a desired level of constraint in six degrees of freedom of movement between paired optical components joined by kinematic connections (e.g., when the molded optical assembly 250 is mated to a molded optical assembly comprising a plurality of corresponding recessed alignment features, as discussed herein). As also illustrated in FIG. 2A, while a kinematic feature 256 of a single protruding alignment feature 252 on a top edge of the molded optical assembly 250 is a protruding ridge extending across a top portion of the protruding alignment feature 252 parallel to the sides of the molded optical assembly 250, the kinematic features 256 of the remaining two protruding alignment features 252 arranged on a bottom edge of the molded optical assembly 250 comprise protruding ridges that are arranged to extend across the tops of their respective protruding alignment features 252 to point inward towards a center of the molded optical assembly 250. Other exemplary embodiments may utilize other shapes and orientations or groove directions to form kinematic features 256.

FIGS. 2B and 2C illustrate a first molded optical assembly 250 aligned and mated with a second molded optical assembly 200. As illustrated in FIGS. 2B and 2C, a plurality of protruding alignment features 252 of the first molded optical assembly 250 are aligned to mate with a plurality of recessed alignment features 202 of the second molded optical assembly 200. As illustrated in FIGS. 2B and 2C, the recessed alignment features 202 may comprise curving recesses. As also illustrated in FIGS. 2B and 2C, the first molded optical assembly 250 comprises a plurality of optical components 254 and the second molded optical assembly 200 comprises a plurality of optical components 204. In one embodiment the optical components 204/254 are optical lenses. In one exemplary embodiment the first molded optical assembly 250 and the second molded optical assembly 200 are optical lens assemblies. As noted above, in other embodiments, the first and second molded optical assemblies 200, 250 may also be optical fibers, lasers, or detector/receivers. As also illustrated in FIGS. 2B and 2C, the optical components 254 of the first molded optical assembly 250 are aligned with the optical components 204 of the second molded optical assembly 200. As illustrated in FIGS. 2B and 2C, when the first molded optical assembly 250 is mated with the second molded optical assembly 200, their respective optical components 254, 204 will be properly aligned such that each optical component 254 is aligned with a corresponding optical component 204 when the pluralities of alignment features 252, 202 of the first and second molded optical assembly 250, 200, respectively, are aligned.

In one exemplary embodiment, as illustrated in FIGS. 2B and 2C, each protruding alignment feature 252 and each recessed alignment feature 202 may also comprise a kinematic or quasi-kinematic feature 256, 202. In one embodiment, as illustrated in FIGS. 2B and 2C, the kinematic features 256 on the protruding alignment features 252 are protruding ridges on the ends of each protruding alignment feature 252. As also illustrated in FIGS. 2B and 2C, the kinematic features 206 on the recessed alignment features 202 are recesses into the bottom of each curved recessed alignment feature 202. As illustrated in FIGS. 2B and 2C, exemplary kinematic features 256, 206 may be orientated and formed to provide a desired level of constraint in six degrees of freedom of movement between paired optical components joined by kinematic connections.

As illustrated in FIGS. 2A-2C, while a kinematic feature 256 of a protruding alignment feature 252 on a top edge of the molded optical assembly 250 is a protruding ridge that extends across a top portion of the protruding alignment feature 252 parallel to the sides of the molded optical assembly 250, the kinematic features 256 of the remaining two protruding alignment features 252 on a bottom edge of the molded optical assembly 250 comprise protruding ridges that are arranged to extend across the tops of their respective protruding alignment features 252 to point inward towards a center of the molded optical assembly 250.

As also illustrated in FIGS. 2A-2C, while a kinematic feature 206 of a recessed alignment feature 202 on a top edge of the molded optical assembly 200 is a crevice that extends across a bottom of the curving recessed alignment feature 202 parallel to the sides of the molded optical assembly 200, the kinematic features 206 of the remaining two recessed alignment features 252 on a bottom edge of the molded optical assembly 200 comprise crevices that are arranged to extend across the bottoms of the curving recessed alignment features 202 to point inward towards a center of the molded optical assembly 200. Other exemplary embodiments may utilize other shapes and orientations or groove directions to form kinematic features 256.

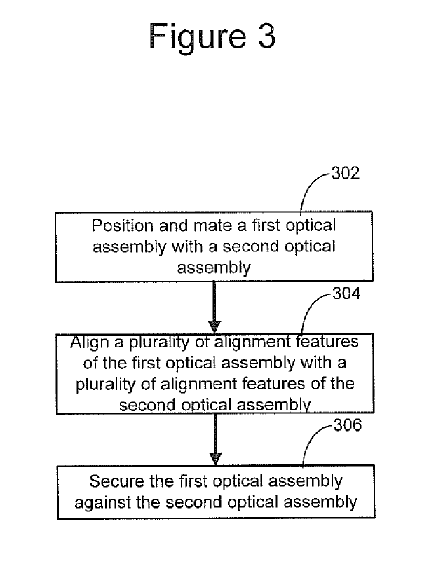

FIG. 3 illustrates exemplary stages of a manufacturing process for forming an optical connection comprising a pair of mated molded optical assemblies. As discussed herein, when alignment features on each of the molded optical assemblies are aligned to their respective alignment features, each optical component installed on the pair of mated molded optical assemblies will be aligned with a corresponding optical component on the opposite molded optical assembly. In step 302 of FIG. 3, a first optical assembly 250 comprising a plurality of first alignment features 252 is positioned against a second optical assembly 200 comprising a plurality of second alignment features 202. In one embodiment, a first alignment feature 252 comprises a protruding alignment feature, while a second alignment feature 202 comprises a recessed alignment feature.

In step 304 of FIG. 3, the first alignment features 252 of the first molded optical assembly 250 are aligned to the second alignment features 202 of the second molded optical assembly 200. As discussed herein, when the alignment features 252 of the first molded optical assembly 250 are aligned to the alignment features 202 of the second molded optical assembly 200, optical components 254 arranged on the first molded optical assembly 250 will be aligned to optical components 204 arranged on the second molded optical assembly 200. As further discussed herein, each optical component arranged on a first molded optical assembly will be aligned with a corresponding optical component arranged on a second molded optical assembly.

In step 306 of FIG. 3, when the first molded optical assembly 250 is mated and aligned with the second molded optical assembly 200, the first molded optical assembly 250 and the second molded optical assembly 200 may be mechanically connected to preserve their positioning and alignment. The mechanical connection may be established via a bonding agent or a mechanical fastening (e.g., a bonding agent may be applied to an interface between corresponding alignment features). In one exemplary embodiment, as illustrated in FIGS. 2B and 2C, the alignment features 252, 202 comprise kinematic alignment features 256, 206, respectively.

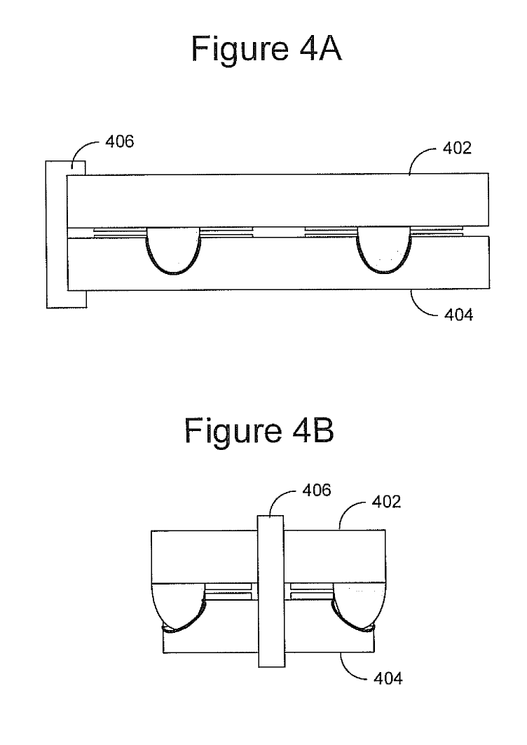

FIGS. 4A and 4B illustrate an exemplary first optical assembly 402 mated to a second optical assembly 404. As illustrated in FIG. 4A, a fastener 406 is used to hold the position of the first optical assembly 402 with relation to the second optical assembly 404. In one exemplary embodiment, the first optical assembly 402 and the second optical assembly 404 are a first optical assembly 150 and a second optical assembly 100, respectively, as illustrated in FIGS. 1G and 1H. In one exemplary embodiment, the fastener 406 is a retainer. In another exemplary embodiment, the fastener 406 is a spring.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A method for aligning two optical assemblies, the method comprising:
positioning a first optical assembly in relation to a second optical assembly, wherein the positioning aligns a plurality of first alignment features of the first optical assembly to a plurality of second alignment features of the second optical assembly; and
securing the first optical assembly to the second optical assembly, wherein aligning the first alignment features to the second alignment features aligns the second optical assembly to a plurality of optical components on the first optical assembly.

2. The method of claim 1, wherein a first alignment feature is aligned to a corresponding second alignment feature when the first alignment feature physically contacts the corresponding second alignment feature.

3. The method of claim 1, the optical components comprise at least one of optical receivers and optical transmitters.

4. The method of claim 1, wherein the second optical assembly comprises an optical lens assembly.

5. The method of claim 1, wherein the plurality of second alignment features comprise a plurality of curved surfaces and the plurality of first alignment features comprise a plurality of matching grooves.

6. The method of claim 1, wherein the plurality of second alignment features comprises three second alignment features, wherein a second alignment feature is arranged on one edge of a side surface of the second optical assembly and a pair of second alignment features are arranged on an opposite edge of the same side surface of the second optical assembly.

7. The method of claim 1, wherein the pluralities of first alignment features and second alignment features comprise at least one of kinematic couplings and pseudo-kinematic couplings.

8. The method of claim 6, wherein one of a kinematic coupling and a pseudo-kinematic coupling tolerance is reduced to control a portion of available freedom of movement between the first optical assembly and the second optical assembly, wherein a remaining portion of available freedom of movement between the first optical assembly and the second optical assembly is allowed to move within limits.

9. The method of claim 1, wherein securing the first optical assembly to the second optical assembly comprises fastening a retainer over the first optical assembly and the second optical assembly.

10. The method of claim 9, wherein the retainer comprises a spring.

11. An alignment apparatus comprising:
a first optical assembly comprising a plurality of first alignment features and a plurality of first optical components;
a second optical assembly comprising a plurality of second alignment features, and
a retainer operable to hold the first optical assembly in physical contact with the second optical assembly, wherein the first alignment features are aligned to the second alignment features, and wherein the second optical assembly is aligned to the plurality of first optical components of the first optical assembly when the first alignment features are aligned to the second alignment features.

12. The alignment apparatus of claim 11, wherein a first alignment feature is aligned to a corresponding second alignment feature when the first alignment feature physically contacts the corresponding second alignment feature.

13. The alignment apparatus of claim 11, wherein the plurality of first optical components comprise at least one of optical receivers and optical transmitters.

14. The alignment apparatus of claim 11, wherein the second optical assembly comprises an optical lens.

15. The alignment apparatus of claim 11, wherein the plurality of second alignment features comprise a plurality of curved surfaces and the plurality of first alignment features comprise a plurality of matching grooves.

16. The alignment apparatus of claim 11, wherein the plurality of second alignment features comprises three second alignment features, wherein a second alignment feature is arranged on one edge of a side surface of the second optical component and a pair of second alignment features are arranged on an opposite edge of the same side surface of the second optical component.

17. The alignment apparatus of claim 11, wherein the pluralities of first alignment features and second alignment features comprises at least one of kinematic couplings and pseudo kinematic couplings.

18. The alignment apparatus of claim 17, wherein one of a kinematic coupling and a pseudo kinematic coupling tolerance is reduced to control a portion of available freedom of movement between the first optical assembly and the second optical assembly, wherein a remaining portion of available freedom of movement between the first optical assembly and the second optical assembly is allowed to move within limits.

19. The alignment apparatus of claim 11, wherein the retainer comprises a spring.
